(19) United States
(12) Patent Application Publication
(10) Pub. No.: US 2018/0164969 A1
(43) Pub. Date: Jun. 14, 2018

(54) DISPLAY WIDGET

(71) Applicant: RA Technology Worldwide LLC, New York, NY (US)

(72) Inventors: David J. KATZ, New York, NY (US); Jeffrey O. SPIEGEL, New York, NY (US)

(21) Appl. No.: 15/837,825

(22) Filed: Dec. 11, 2017

Related U.S. Application Data
(60) Provisional application No. 62/432,095, filed on Dec. 9, 2016.

(51) Int. Cl. G06F 3/0484; H04M 1/725; G06F 1/16; G06F 3/0481; H04B 1/3827; H04N 5/225

(52) U.S. Cl. CPC G06F 3/0484; H04M 1/72527; H04M 1/72547; H04N 5/2252; G06F 3/04817; H04B 1/385; G06F 1/163

(57) ABSTRACT

A wearable device is described. The wearable device can include a display screen and an outer housing. The outer housing can include a processor, a memory, and a transceiver. The outer housing can be attached to the display screen, and the outer housing can be mounted on an article of clothing. The processor is configured to receive via the transceiver a media from a smart device, and the processor is also configured to cause display of the media on the display screen.

### A. CROSS-REFERENCE TO RELATED APPLICATION

The present application claims the benefit of U.S. Provisional Patent Application No. 62/432,095 filed Dec. 9, 2016, incorporated by reference in its entirety herein.

### B. COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### C. BACKGROUND

Humans are social animals and are inclined to visibly share their interests, achievements, and affiliations with other humans. As a result, and throughout history, humans have created items that outwardly reflect their respective interests, achievements, and affiliations. For example, at a basketball game, a fan of one of the teams wears a jersey including that team's logo to outwardly express that the fan is rooting for that team, or is affiliated with that team or school. Wearing of the jersey also creates an opportunity for the fan to socialize with other fans of that team at the game or elsewhere. Similarly, at a political rally, an individual might wear a button including a political party's slogan. Wearing the button can create a sense of unity among the party's supporters and provides an opportunity for supporters to express their political affiliations and aspirations. Graduates often wear rings, hats, or accessories indicating their Alma Mater. Award winners, phi beta kappa recipients or girl scout badges, for example, may externally display their achievements. By wearing these outward indicia of interests, achievements, and affiliations, individuals can express themselves and create opportunities to meet other individuals who have similar interests, achievements, and affiliations.

### BRIEF DESCRIPTION OF THE DRAWINGS

FIG. 1 represents an exemplary outer housing of a Widget according to an example embodiment.

FIG. 2 illustrates an example charging port of a Widget according to an example embodiment.

FIG. 3 shows an example display screen of a Widget.

FIG. 4 illustrates an exemplary switch provided on an outer housing of a Widget.

FIG. 5 illustrates a frame according to an example embodiment.

FIG. 6 shows an example attachment mechanism which can include a plate.

FIG. 7 shows an example embodiment in which a Widget is connected to a plate and both the Widget and the plate have been inserted inside a frame.

FIG. 8 shows mounting or attachment of a Widget onto an article of clothing.

FIG. 9 shows a plate to back of which a safety pin is attached.

FIG. 10 shows a plate including a safety pin.

FIG. 11 shows a frame attached to a Widget and the plate includes a safety pin that is secured between the frame and the Widget.

FIG. 12 shows an example attachment mechanism that can provide for charging of a Widget.

FIG. 13 shows an example embodiment of a Widget inserted inside a frame.

FIG. 14 illustrates mounting or attachment of a Widget to an article of clothing and a secondary battery.

FIG. 15 shows various views of a Widget mounted by a user on an article of clothing.

FIG. 16 shows various shapes of a Widget.

FIG. 17 shows an example flow process for pairing a Widget with a Smart Device.

FIG. 18 is an example flow process for selecting a media on a Smart Software and displaying it on the Widget.

FIG. 19 provides an example flow process for an application which can provide notifications to a user on a user's Widget.

FIG. 20 shows a flow process for notifying a user by the Widget when the user leaves behind the user's Smart Device.

### E. DETAILED DESCRIPTION

With the advent of computer technology, the internet, and social media individuals are finding an ever increasing number of ways to express themselves in cyberspace. For example, an individual can express the individual's happiness or sadness with a given situation on a social media platform. Using such technologies, an individual can dynamically express himself or herself, i.e., the individual can quickly adapt his or her technology enabled expressions to the individuals' situational feelings, interests, needs, etc. It is important to note that the current expression of these feelings and interests, although “social” and “shared” via the internet, is actually “private,” as the visible display is via a smartphone or personal computer visible only to the user.

Further, traditional indicia of interests, achievements, and affiliations have remained static, i.e., once created or worn they do not change and they are unable to react to the individuals' evolving needs. Advancements in wearable technologies have the potential to facilitate an individual's wish to dynamically express himself or herself. It is an objective of this disclosure to describe a Widget that enhances the ability of an individual to outwardly express interests, achievements and affiliations of the individual in an external, highly visible, personalized, progressive and adaptive fashion.

1. The Hardware Aspects of the Widget

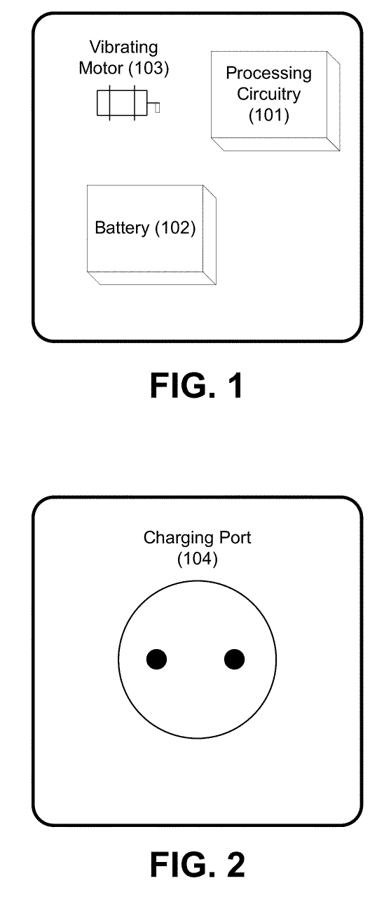

The Widget according to the present invention can include a display screen and an outer housing, in which there are processing circuitries and a battery. FIG. 1 represents an exemplary outer housing according to an example embodiment. On the inside of the outer housing, a processing circuitry 101 and a battery 102 are located. The processing circuitry 101 includes a processor, a memory device, and a transceiver. The battery 102 can be any one of the following types of batteries: Lithium Ion, Lithium Polymer, Nickel Cadmium, and Nickel Metal Hydride. Other types of batteries are also conceivable to one of ordinary skill in the art.

In some embodiments, the outer housing can include a charging port for supplying energy and communicating information to the Widget. FIG. 2 illustrates an example charging port 104 according to an example embodiment. The charging port 104 can be located on the back or outside of the outer housing and is connected to the battery 102. Alternatively, the charging port can be placed on any one of the sides of the outer housing. Using the charging port, in addition to charging the battery 102, the user of the Widget can electrically connect the Widget to other devices, such as a laptop, desktop, tablet, cellphone, etc., and manipulate the software stored on the processing circuitry 101 of the Widget.

In other embodiments, the Widget is not provided with a charging port. In these embodiments, the device can be charged wirelessly or inductively. Inductive charging takes advantage of the principles of electromagnetic induction to transfer electric energy from a base to the Widget without any electric connection. Accordingly, the base is provided with an induction coil to create an alternating electromagnetic field from within the base. A second induction coil is provided in the Widget, which is configured to take power from the electromagnetic field, and convert it back into electric current to charge the battery. In effect, the two induction coils in proximity combine to form an electrical transformer. In the embodiments provided with inductive charging, the user of the Widget can place the Widget over, by, or within the vicinity of the base. Subsequently, the Widget determines that the Widget is placed over, by, or within the vicinity of the base and begins receiving charge from the base. Although charging using a charging port and charging inductively are described separately, in certain embodiments the Widget can be capable of being charged both inductively and by using a port.

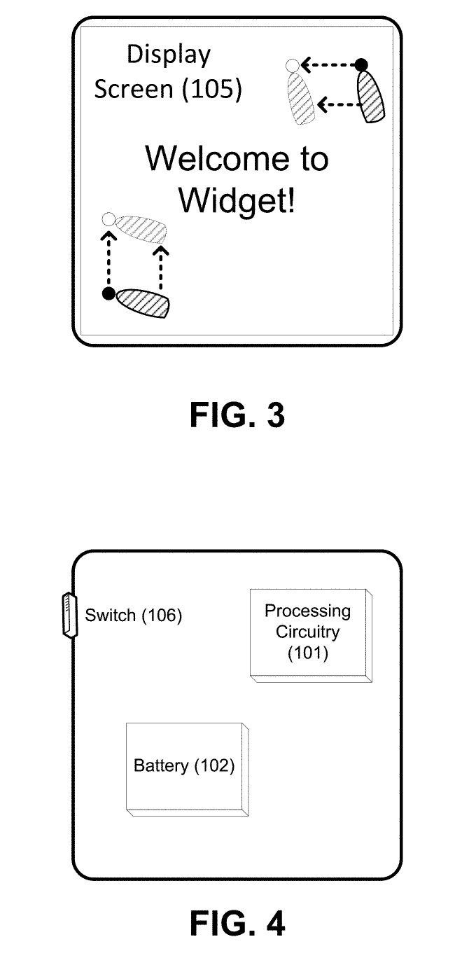

The display screen covers the front of the Widget and the display screen can be an OLED, AMOLED, e-Ink, color paper ink, or other display screens known to persons of ordinary skill in the art. The display screen can be a touchscreen device, which can enable the Widget to receive touch commands from the user. FIG. 3 shows an example display screen 105, which is touchscreen.

A touch command can include performing one of the following actions on the screen of the Widget: tapping, double tapping, swiping, long pressing, long-press and dragging, double-tap dragging, pinching open, pinching closed, two finger touching, two finger swiping, two finger long-pressing, two finger long-press swiping, two finger double tapping, and two finger rotating.

In some embodiments the Widget is provided with a vibrating motor. The vibrating motor can be an electric motor with an unbalanced mass on its driveshaft. FIG. 1 shows a vibrating motor 103 according to an example embodiment. The vibrating motor can be electrically coupled to the processing circuitry 101 and mechanically coupled to the outer housing, the display screen 105, or other parts of the Widget. The vibrating motor 103 can be used by the processing circuitry to vibrate the Widget, and thereby provide vibration alerts to the user of the Widget. Using the vibration alerts, the Widget can notify the user of an incoming notification from the device that is paired to the Widget, thereby updating the Widget's external display. As another example, the Widget can generate vibrating alerts when the Widget is disconnected from the device which is paired to the Widget. Other uses of the vibrating alerts are also conceivable.

In some embodiments, the outer housing can be provided with one or more buttons or switches for the user to communicate with the Widget. For example, on the outer housing of the Widget one or more buttons can be provided to turn off the display screen, to activate the Bluetooth discoverability of the Widget, or to change the brightness of the display screen 105. FIG. 4 illustrates an exemplary switch 106 provided on the outer housing of the Widget. In an example embodiment, by pressing the switch 106 the user can turn off the Widget. Other functionalities are also conceivable. For example, by holding the switch 106 for a few seconds, the discoverability mode of the Widget can be activated.

In some embodiments, the Widget is provided with a camera. The camera is electrically coupled to the processing circuitry 101. The camera can be located on the front of the Widget. For example, the camera can be included next to the display screen 105 or on the display screen 105. In some embodiments, the camera can be a separate component attached to the housing of the Widget.

In some embodiments, the Widget is provided with a microphone. The microphone is electrically coupled to the processing circuitry 101. The microphone can be located on the front of the Widget. For example, the microphone can be included next to the display screen 105 or on the display screen 105. In some embodiments, the microphone can be a separate component attached to the housing of the Widget. In other embodiments, the microphone can be placed inside the housing of the Widget. The microphone can enable the user to provide voice commands to the Widget.

In some embodiments, the Widget is provided with a speaker. The speaker is electrically coupled to the processing circuitry 101. The speaker can be located on the front of the Widget. For example, the speaker can be included next to the display screen 105 or on the display screen 105. In some embodiments, the speaker can be a separate component attached to the housing of the Widget.

The Widget can be configured to be paired with another device (“Smart Device”), which can be a smartphone, cell phone, a laptop, a desktop, a notebook, a tablet, a wearable device, etc. Pairing the Widget with the Smart Device establishes an initial bonding between the Widget and the Smart Device so that communication is allowed and facilitated between the two devices. In an example embodiment, the Widget can use Bluetooth wireless technology standard for exchanging data and communication between the Widget and the Smart Device. Other wireless technology standards such as Induction Wireless, Infrared Wireless, Ultra Wideband, ZigBee, or a combination thereof are also conceivable.

In an example embodiment, during pairing, a link key is used, which can be a shared secret known between the Widget and the Smart Device. If both devices store the same link key, they are said to be paired or bonded. In some embodiments, it is possible to limit the communication of the Widget only to a Smart Device that was previously paired with the Widget. Such limitation can be implemented by cryptographical authentication of the identity of the Smart Device by the Widget to ensure that the Smart Device is the Smart Device that was previously paired with the Widget. Protection against eavesdropping is also possible by encrypting the exchanged data between the Widget and the Smart Device. Users can delete link keys from either device, which removes the bond between the devices. It is possible for one device to have a stored link key for a device with which it is no longer paired.

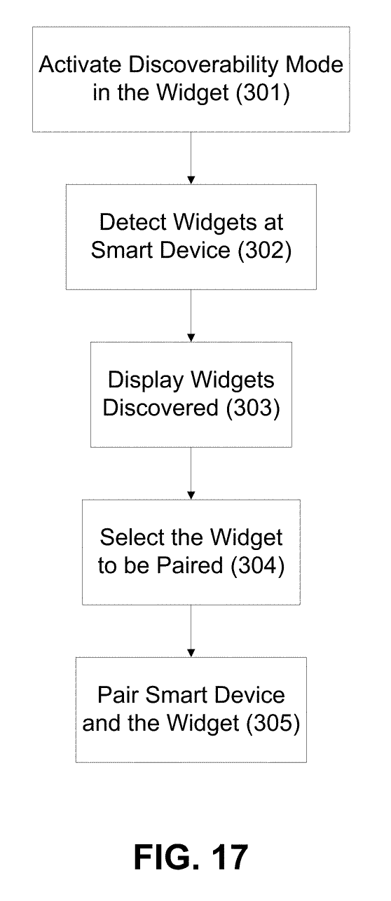

FIG. 17 shows an example flow process for pairing a Widget with a Smart Device. In this example embodiment, pairing can start by the user initiation of discoverability mode in the Widget in step 301. In the discoverability mode, the Smart Device can detect the Widget and let the user know the identity of the Widget, for example, by displaying it. The discoverability mode, for example, can be initiated by pressing the switch 106 in FIG. 4 for a few seconds. In step 302, the user can request the Smart Device to detect Widgets around the Smart Device. For example, the user can make the detection request by choosing an “Add a Bluetooth Device” on the Smart Device. Subsequently, the Smart Device seeks Widgets (and other devices) close to the Smart Device and at step 303 displays the identity of any Widgets (and other devices) discovered by the Smart Device. At step 304, the user can select the Widget that the user intends to pair with the Smart Device. At step 305, the Smart Device can form a bond between the Widget and the Smart Device, and the Widget and the Smart Device will be able to communicate thereafter. Over the subsequent interactions, the Widget and the Smart Device can connect to each other by reverting to the bond that has already been established. The user can sever the bond (i.e., deleting the link key) at any time, thereby terminating the communication link between the Widget and the Smart Device.

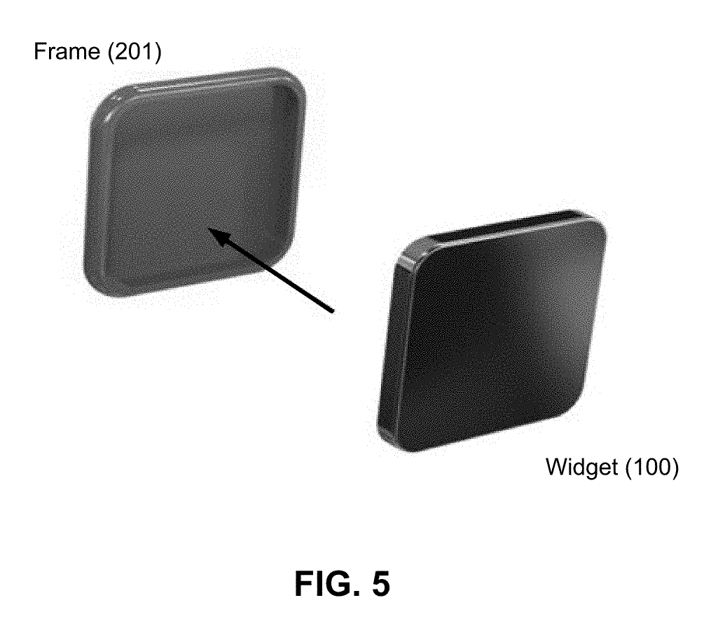

In some embodiments, the outer housing of the Widget can be covered by a case or frame. The case or frame can provide protection for the Widget or can enhance the Widget aesthetically. The frame can be made from a softer or gentler material to protect the outer housing of the Widget against dropping or shocks of similar nature. However, the frame can also be made from rigid material for the same purposes or for other purposes. FIG. 5 illustrates a frame 201 according to an example embodiment. The frame 201 in this example embodiment is made from silicon and is configured to be fitted around the Widget 100 so that the frame 201 can protect the Widget against accidental drops.

While some embodiments are described as having a frame, other embodiments do not include any frame.

In some embodiments, the housing of the Widget is configured to be attachable to an article of clothing. Various, and interchangeable, attachment mechanisms can be used to attach the Widget to the article of clothing. Similarly, interchangeable frames can be used to hold and display the Widget.

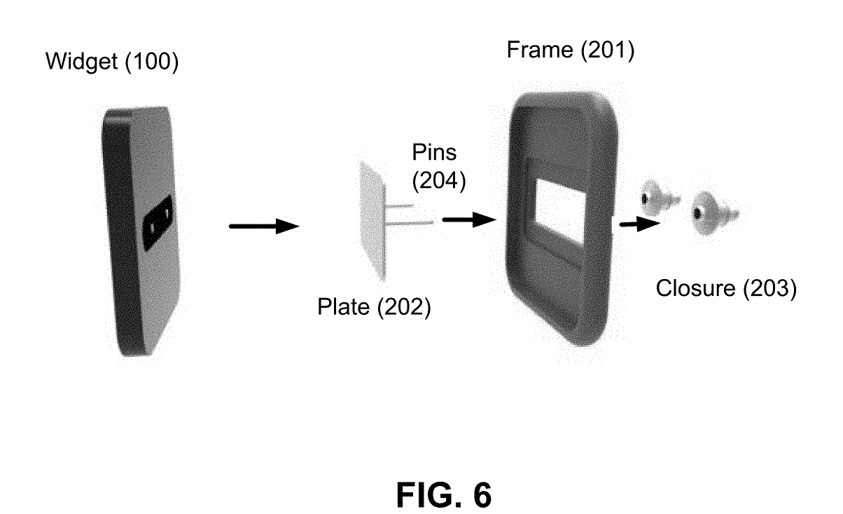

FIG. 6 shows an example attachment mechanism which can include a plate 202. The plate 202 can include a front side and a back side. On the front side, the plate can attach to the outer housing of the Widget 100 using a magnet, an adhesive, a Velcro, a clip connection, etc. On the back side of the plate 202, at least one pin can be perpendicularly connected to the back side of the plate 202. The at least one pin is configured to pierce or pass through the article of clothing on a first side and be secured on a second side. In FIG. 6, the plate 202 is provided with two pins 204, and each of the pins is configured to be secured to closures 203 and the second side of the article of clothing.

In another embodiment of the plate 202, the plate 202 can clip into the frame 201, thereby obviating the need for any connection elements on the front side of the plate 202 to connect the plate 202 to the Widget 100. However, embodiments of the plate 202 in which both the plate 202 clips to the frame 201 and connection elements on the front side of the plate 202 are provided, are conceivable as well. In certain other embodiments, the plate 202 is permanently connected to either or both of the Widget 100 or the frame 201.

While in FIG. 6 closures 203 were used to secure the pins 204 of the plate 202 on the second side of the article of clothing, other fasteners also can be used to hold the Widget onto the article of clothing. For example, one can use screws, bolts, nuts, magnets, etc., instead of or in addition to the pins 204 and the closures 203 on the plate 202. In certain embodiments, the closures 203 can be permanently connected to the article of clothing, causing the Widget 100 to be mounted on the same exact spot each time it is worn by the user.

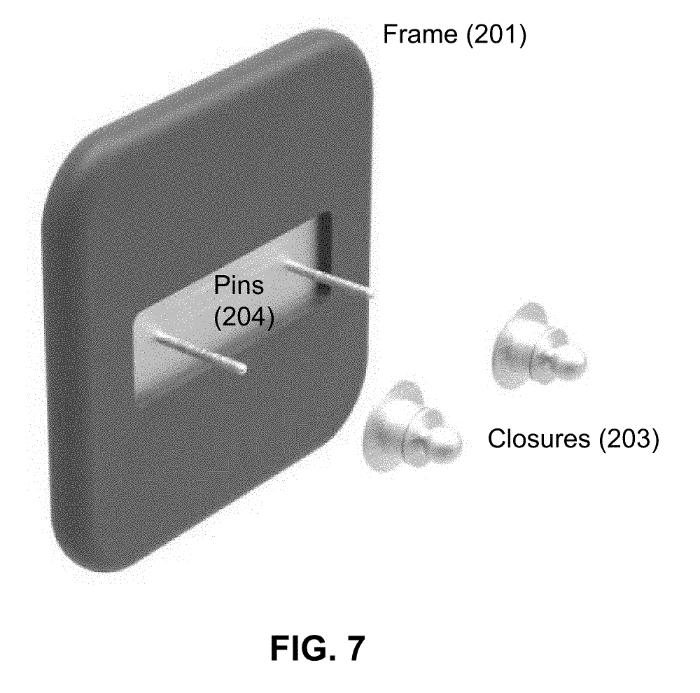

FIG. 7 shows an example embodiment in which the Widget 100 is connected to the plate 202 and both the Widget 100 and the plate 202 have been inserted inside the frame 201. The pins 204 can pass through an article of clothing and be secured to closures 203, thereby preventing the Widget 100, frame 201, and the plate 202 from falling or detaching from the article of clothing. FIG. 7 shows the back side of the plate 204.

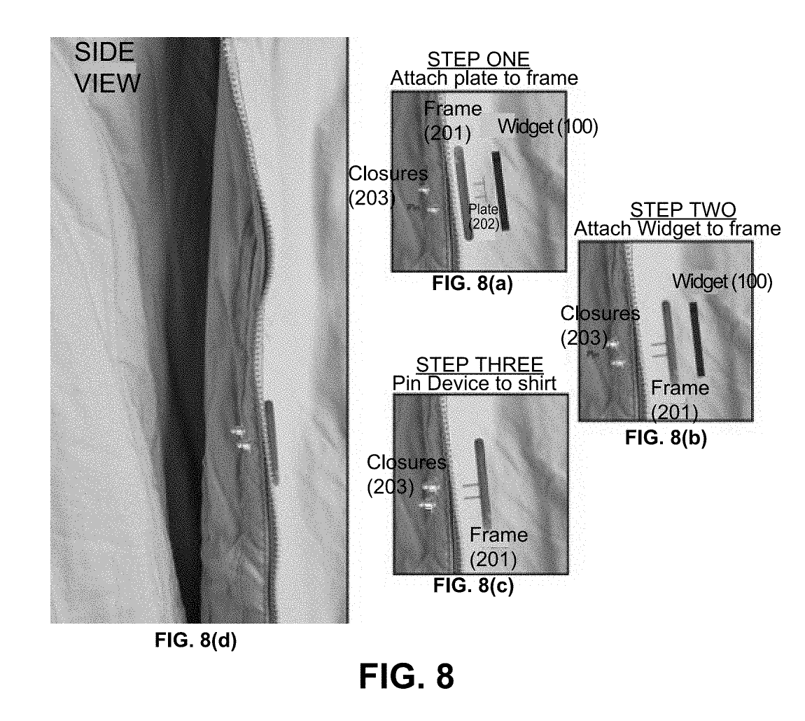

FIG. 8 shows mounting or attachment of the Widget 100 to an article of clothing. In FIG. 8, the plate 202 is configured to be attached to the frame 201. The Widget 100 is configured to be inserted into the frame 201. The closures 203 are permanently attached to the article of clothing. The user of the Widget can press the pins 204 into the closures 203, thereby fixing the Widget 100, the plate 202, and the frame 201 to the article of clothing.

In this example embodiment shown in FIG. 8, mounting or attachment of the Widget 100 to the article of clothing can include three steps. In the first step, the user can attach the plate 202 to the frame 201 as shown in FIG. 8(a). In the second step, the user can attach the Widget 100 to the frame 201 as shown in FIG. 8(b). In the third step, the user can pin the Widget 100, the plate 202, and the frame 201 to the closures 203 as shown in FIG. 8(c). FIG. 8(d) shows a side view of the mounted Widget 100 after all the steps were carried out by the user.

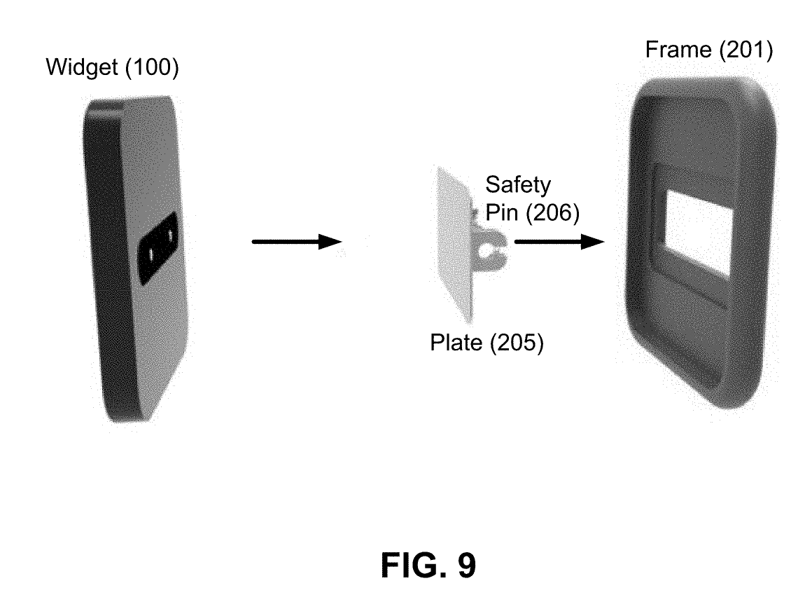

In another example attachment mechanism, the plate is configured so that on the back side of the plate a safety pin can be connected to the plate. FIG. 9 shows a plate 205 to the back of which a safety pin 206 is attached. The safety pin is configured to open and close, and once the pin passes through the article of clothing, the pin can secure the plate 205 (and whatever is connected to the plate 205) to the article of clothing. In this embodiment, the plate 205 can be configured to be connected to either the Widget 100 or to the frame 201. In the case of connection to the Widget 100, the front of the plate 205 can connect to the Widget 100 using any combination of a magnet, an adhesive, a Velcro, a clip connection, etc. In the case of connection to the frame 201, the plate 205 can clip into the frame 201. Moreover, in certain embodiments, the plate 205 can permanently be connected to either or both of the Widget 100 or the frame 205. As the plate is configured to attach to the outer housing of the Widget 100 directly or indirectly via the frame 201, using the plate 205, the outer housing of the Widget can be secured to the article of clothing.

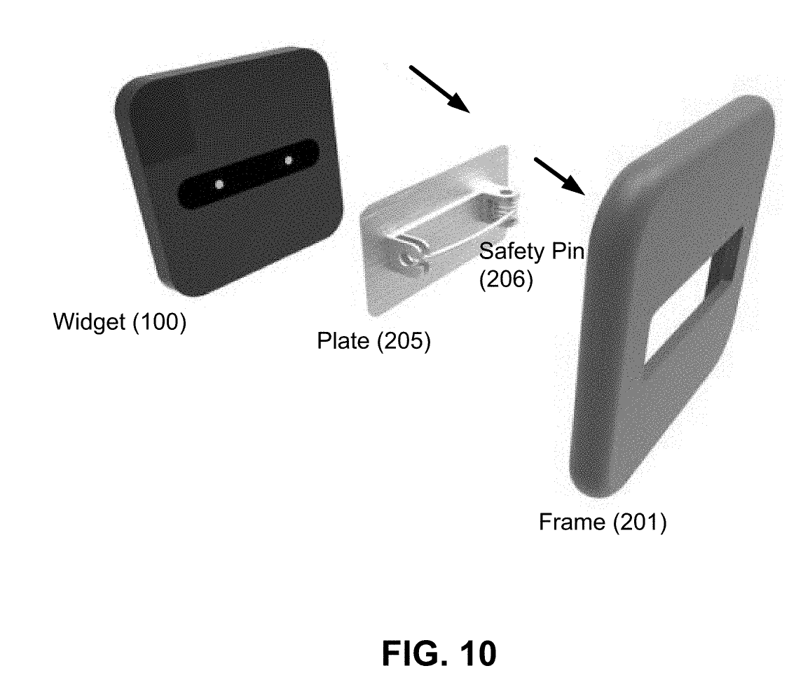

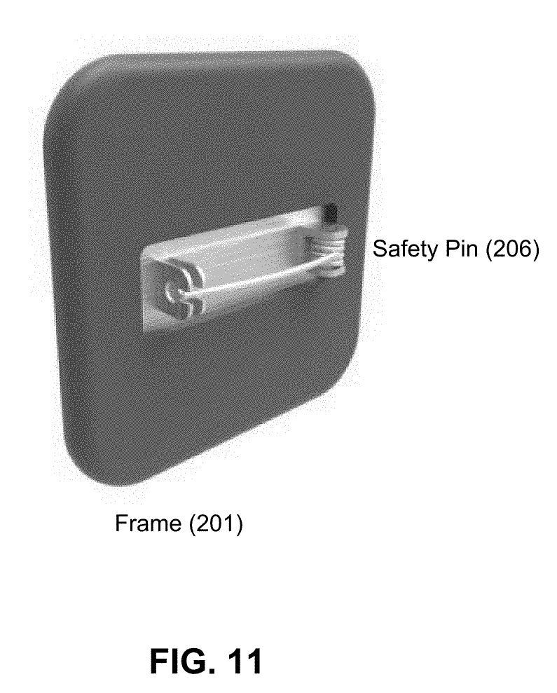

FIG. 10 shows the plate 205 including the safety pin 206. As shown, in this embodiment, the plate 205 is configured to be clipped into the frame 201, and the frame 201 is configured to be attached to the Widget 100. FIG. 11 shows the frame 201 attached to the Widget 100 and the plate 205 including the safety pin 206, which is secured between the frame 201 and the Widget 100.

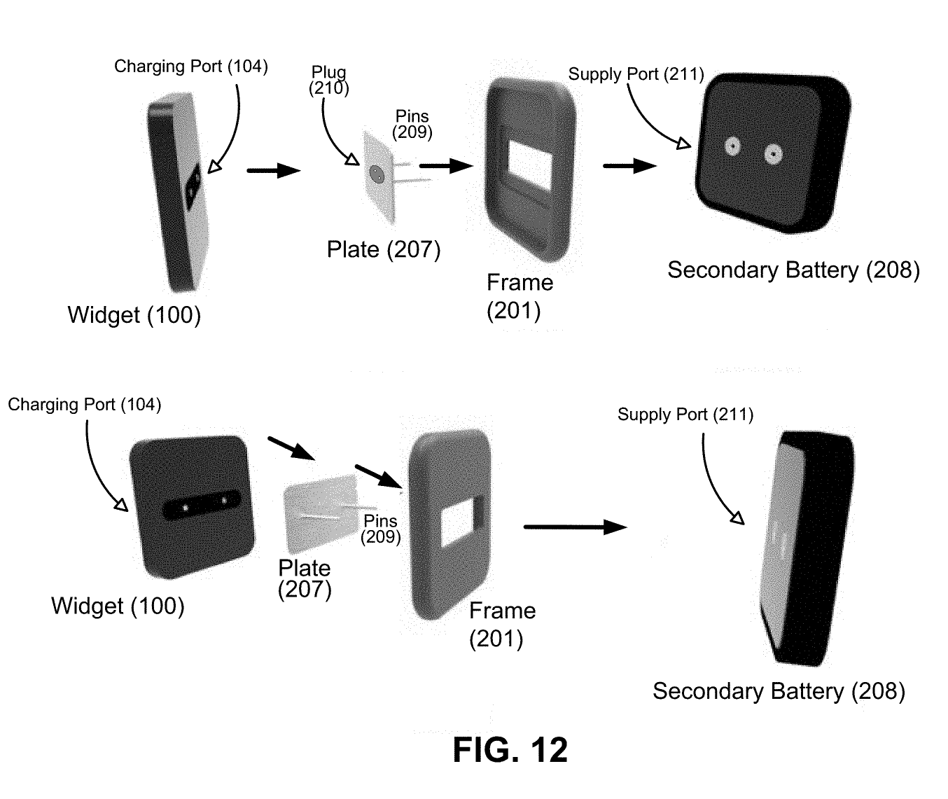

In yet another example attachment mechanism, the plate can provide for convenient charging of the Widget while the device is mounted on the article of clothing. FIG. 12 shows an example attachment mechanism that can provide for charging of the Widget. In this example embodiment, the plate 207 can have at least two pins 209 perpendicularly connected to the back side of the plate 207. The pins 209 can be electrically conductive, can pass through the plate 207, and can be electrically connected to the plug 210. The plug 210 is configured to connect to the charging port 104 of the Widget 100. The pins 209 can be further configured to pass through a first side of an article of clothing and be secured to a source of charge on a second side of the article of clothing. Although the example embodiment of FIG. 12 includes the plate 207, the pins 209, and the plug 210 for electrically connecting the secondary battery 208 to the charging port 104 of the Widget 100, one of ordinary skill in the art recognizes that other electrical connections are also possible.

In this embodiment, the plate 207 can be configured to be connected to either the Widget 100 or to the frame 201. In the case of connection to the Widget 100, the front of the plate 207 can connect to the Widget 100 using any combination of a magnet, an adhesive, a Velcro, a clip connection, etc. In the case of connection to the frame 201, the plate 207 can clip into the frame 201. Moreover, in certain embodiments, the plate 207 is permanently connected to either or both of the Widget 100 or the frame 201.

The source of charge can include a secondary battery 208. The secondary battery 208 can be any one of the following types of batteries: Lithium Ion, Lithium Polymer, Nickel Cadmium, and Nickel Metal Hydride. The secondary battery 208 can also include a supply port 211. The supply port 211 is configured to electrically connect to the pins 209 and supply electric charge through the pins 209.

By using the plate 207, the Widget 100 can be electrically connected to the secondary battery 208, thereby providing the user with the option to have the Widget 100 stay charged for a longer period of time.

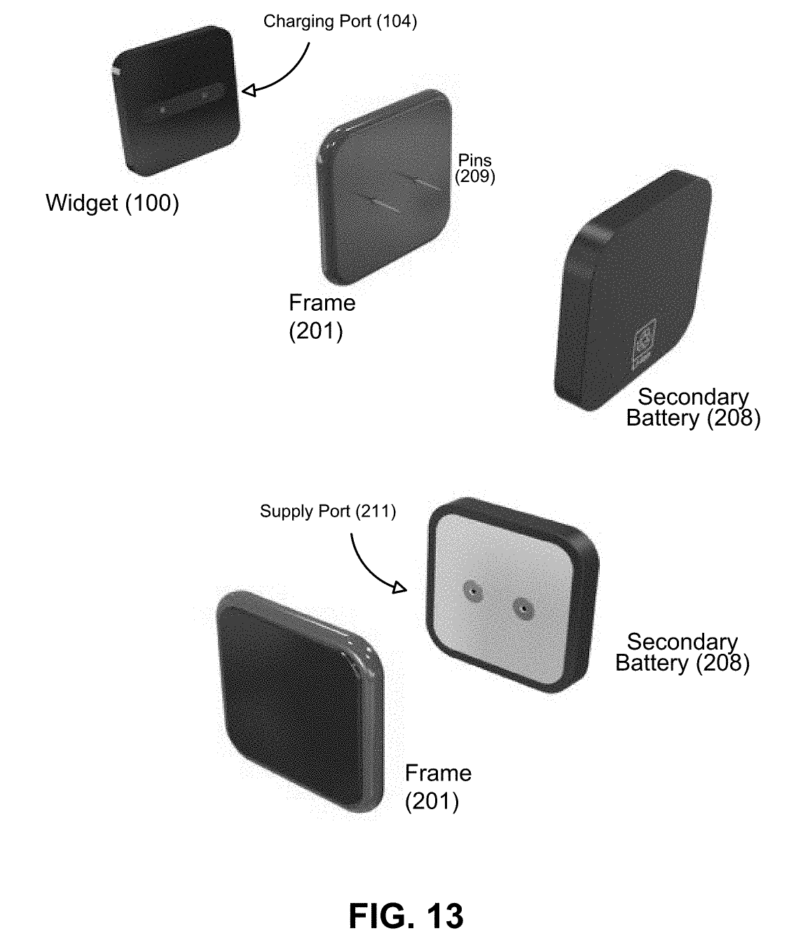

FIG. 13 shows an example embodiment of a Widget inserted inside a frame. In this example embodiment, the plate 207 is permanently connected to the frame 201. The drawing on the top shows the Widget 100 before the Widget 100 is inserted into the frame 201. The drawing on the bottom shows the Widget 100 inserted into the frame 201.

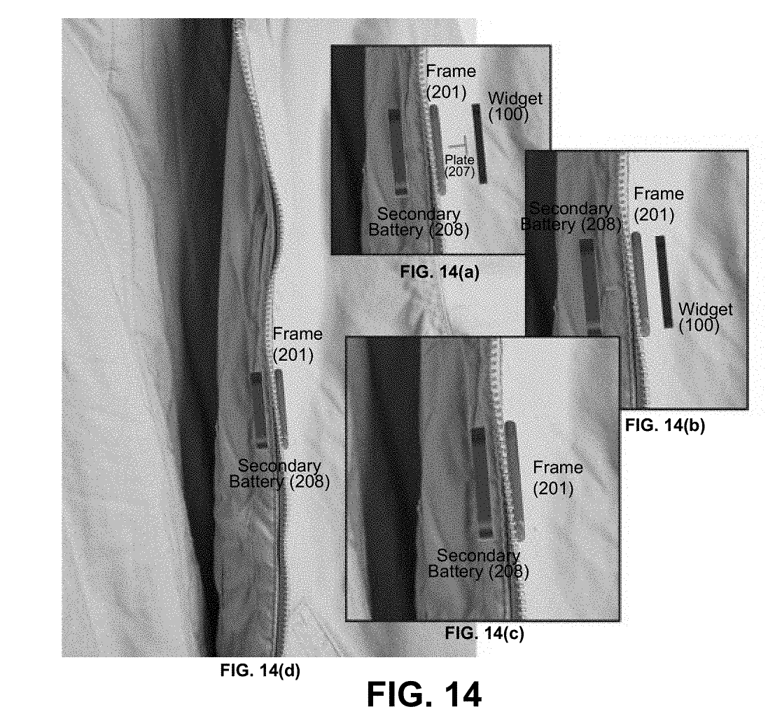

In FIG. 14 mounting or attachment of the Widget to an article of clothing and a secondary battery is displayed. The mounting or attachment can include three steps. In the first step, the user can attach the plate 207 to the frame 201 as shown in FIG. 14(a). In the second step, the user can attach the Widget 100 to the frame 201 as shown in FIG. 14(b). In the third step, the user can pin the Widget 100, the plate 207, and the frame 201 to the secondary battery 208 in the supply port 211 as shown in FIG. 14(c). FIG. 14(d) shows a side view of the mounted Widget 100 after all the steps were carried out by the user.

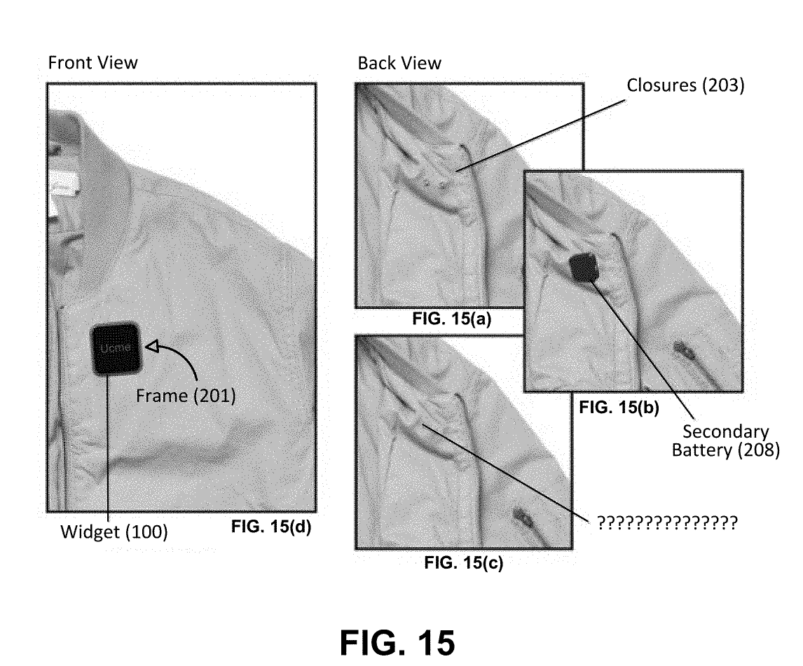

FIG. 15 shows various views of a Widget mounted by a user on an article of clothing. FIG. 15(a) shows a back view of a Widget mounted on an article of clothing and the Widget is held to the article of clothing with the help of the closures 203. FIG. 15(b) shows a back view of a Widget mounted on an article of clothing and the Widget is held to the article of clothing with the help of the secondary battery 208. FIG. 15(c) shows a back view of a Widget mounted on an article of clothing and the Widget is held to the article of clothing with the help of the plate, frame, and attachment pins. FIG. 15(d) shows a front view of a Widget 100 including a frame 201 together mounted on an article of clothing.

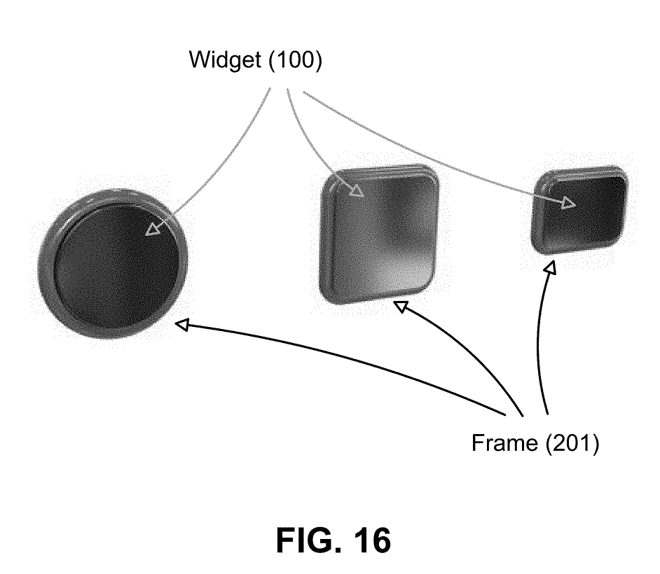

FIG. 16 shows various shapes of a Widget. The outer housing and the display screen of the Widget 100 can be the shape of a circle, square, or a rectangle. Other shapes are also possible. Similarly, the frame 201 can have any of the preceding shapes, and different interchangeable frames can be elected by the user to meet various moods and wearing occasions.

2. Widget Software and Smart Software

The Widget performs the functionalities described herein using a Widget Software installed on the Widget (“Widget Software”). The Widget Software provides for interaction with a Smart Device, and is capable of pairing the Widget with the Smart Device. The software is also capable of receiving media from the software installed on the Smart Device (“Smart Software”) and displaying the media on the display screen of the Widget. The Smart Software is also configured to interact with the Widget Software.

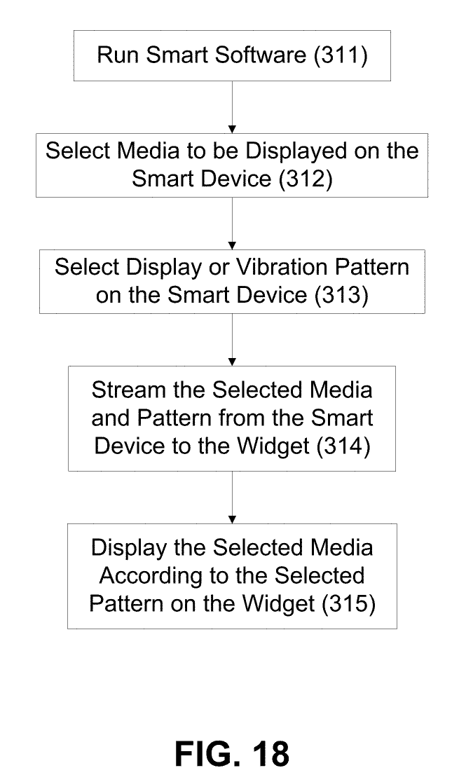

FIG. 18 is an example flow process for selecting a media on the Smart Software and displaying it on the Widget. In this embodiment, the user can start the Smart Software at step 311 and the user can select the media that the user intends to display on the Widget at step 312. For example, on the Smart Software interface, the user can select a “display a media option.” Upon selecting this option, the user can be prompted to another page, on which, the user can be asked to select the media which the user intends to display on the Widget. For example, the user can select a logo from the library of the user's cell phone to be displayed on the Widget. As another example, the user can select a video from the library of the user's Smart Device to be displayed on the Widget.

Once the media is selected, the user can select whether the user intends the Widget to utilize a display pattern, vibration pattern, both, or none as the media being displayed. The pattern selection can take place at step 313 of FIG. 18. A display pattern is a pattern of change of the brightness, sharpness, color, contrast, etc., of the display screen while the media is being displayed on the display screen. For example, the user can select flashing as the display pattern. In this example, the selected media can be displayed for a period of time and then not be displayed for another period of time. The user can select how long the media is being displayed and how long the media is not being displayed, or the user can select a ratio of display relative to non-display of the media. The user can also decide the frequency of flashing, e.g., 2 Hz, 1 Hz, 0.5 Hz, etc. In another example, the display pattern can include a variable brightness or intensity. In this example, once the media is displayed, the brightness or intensity level of the display screen decreases and then increases to its original level. Other display patterns such as a combination of flashing and change in brightness are also conceivable.

A vibration pattern is a pattern that determines how fast and for how long the vibrator of the Widget vibrates while the Widget displays the media. The length of vibration can be a ratio of vibration to non-vibration of the vibrator, or the length can be a specified number of seconds or minutes. For example, the user can select a vibration pattern as follows: half a second of vibration for every 4 seconds of time elapsed. As another example, the user can select the intensity level for vibration of the Widget while the media is being displayed on the Widget, e.g., 100 rpm, 200 rpm, etc.

Upon selection of the media to be displayed, the display pattern, and the vibration pattern, the Smart Device can communicate or stream the media to the Widget. The Smart Device can also communicate any display pattern or vibration pattern selected, if any, by the user on the Smart Software to the Widget. This communication of the media selected and any pattern chosen to the Widget can take place at step 314. The transceivers of the Widget can receive the media and any patterns selected, and the Widget Software can display the media (and any patterns selected) on the display screen of the Widget at step 315.

A user's interaction with the Smart Device and the Smart Software can take place using the well-known methods and techniques in the art. For example, the user can interact with and provide input to the Smart Device and the Smart Software using touch or voice commands. In addition, it is possible to select a media via the Widget Software for display on the Widget. For example, the Widget Software can display to the user various media available on the Widget (or Smart Device) for displaying and the user can select the media using a touch or a voice command. For example, using a voice command, the user can trigger display of specific images, or streams of images on the Widget display. This voice command can be received via the microphone of the Widget or the microphone of the Smart Device.

Furthermore, although in the example embodiment of FIG. 18 the user selected the media to be displayed on the Widget, it is possible for the media to be selected using a software other than the Smart Software, an artificial intelligence, or by using machine learning from the Smart Device.

In another embodiment, the user selects an application on the Smart Software and the Smart Software provides access to the application selected by the user. In turn, the application decides what content will be displayed on the Widget Software. Providing access to the application can include providing direct access to the Widget so that the application can stream to the Widget directly or it can include providing access to the Smart Software so that the application can broadcast media to the Smart Software and the Smart Software can stream the broadcasted media to the Widget. For example, the user can select a live TV application as the application that would broadcast media to the Widget. The user can give access to the application either in the live TV application itself or in the Smart Software. Once access is provided, transmission or sharing of the images to the Widget is enabled, either directly or through the Smart Software. As a result, the live TV application can provide or streams images to the Smart Software and the Smart Software in turn can broadcast, transmit, or stream the media to the Widget. Direct broadcasting or streaming of the images to the Widget by the live TV application is also possible.

As another example, the application can be an application provided by a retail store (“Retail Application”). The Retail Application can notify an assistant in a department store that a customer needs help with a specific item or service. The application can also receive notifications from the user, the store, or the assistant. In this example, if a customer visiting a store needs help, the customer can notify the store by using the Retail Application. Once an assistant is dispatched, the assistant can send a notification to the customer's Smart Device. The Retail Application of the customer's Smart Device receives the notification, and in turn transmits this information to the Smart Software. This information can be in the form of a media to be displayed on the Widget. This information can also be a display pattern or a vibration pattern to be used while displaying the media.

The Smart Software can also receive this information from the Retail Application and can cause the transmitters of the Smart Device to transmit this information to the Widget. For example, the media can be a logo of the store, and the application can choose continuous vibration as the vibration pattern of the Widget. Thus, upon receiving the notification by the Retail Application of the Smart Device, the Widget displays the store's logo and vibrates. Consequently, the customer is informed that an assistant is looking for the customer and the assistant can spot the customer by looking for the customer's Widget. While in this embodiment the Smart Software acted as an intermediary between the Retail Application and the Widget, in other embodiments the Retail Application can directly broadcast a media and a pattern to the Widget without interference by the Smart Software. Moreover, while in this embodiment a Retail Application was used to provide notifications to the customer, in other embodiments, the notifications can be received by a text message, a phone call, a video call, etc. This application allows an assistant to readily identify a customer in need of specific assistance.

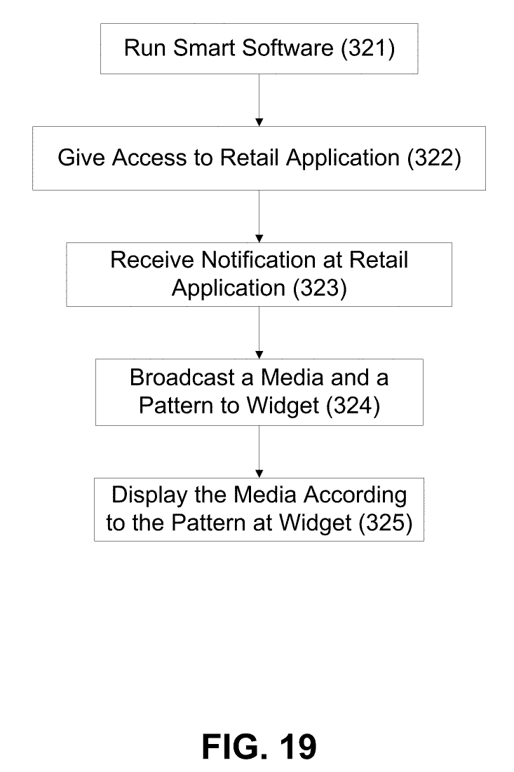

FIG. 19 provides an example flow process for an application that can provide notifications to a user on a user's Widget. In this example, the user runs the Smart Software at step 321 and provides access to the Retail Application at step 322. Subsequently, at step 323, the user receives a notification at the Retail Application. At step 324, the Retail Application directly broadcasts a media and a vibration pattern to the user's Widget. Upon receiving the media and the vibration pattern via the transceiver of the Widget, at step 325, the Widget Software causes the display screen of the Widget to display the media and causes the vibrating motor of the Widget to vibrate according to the provided pattern.

3. Functionalities of the Widget

In an example embodiment, the Widget is enabled to alert the user if the user leaves behind the Smart Device paired with the Widget. The Widget can achieve this purpose using two different technical implementations. In a first technical implementation, the Smart Device is considered to be left behind if the Widget is disconnected or the pairing is severed from the Smart Device. In this technical implementation, the Widget continuously or intermittently can check its paring or connection with the Smart Device to determine whether the connection still exists. If the connection exists, the Widget continues operation. However, if the Widget determines that the connection has been lost, the Widget determines whether it should alert the user. The user can set a threshold time period for the Widget to wait before alerting the user. Setting a threshold time period is optional. If during this time period the pairing or connection is restored, the Widget does not alert the user. However, if the connection is still not restored, the Widget alerts the user. The alert can be in the form of showing an image or video, vibration of the Widget, or a combination thereof.

In the second technical implementation, the Widget alerts the user based on the distance of the Widget from the Smart Device. In this technical implementation, the Widget Software can determine the distance of the Widget from the Smart Device. The user can set a predetermined separation distance between the Widget and the Smart Device over which the user wants to be alerted by the Widget. The Widget is considered to be disconnected from the Smart Device when the distance between the Widget and the Smart Device increases to a distance over the predetermined distance. Similar to the previous technical implementation, the Widget continuously or intermittently scans the Smart Device. Once the Widget is disconnected from the Smart Device (i.e., the separation distance increases to a distance over the predetermined distance), the Widget determines whether to alert the user. In some embodiments, the user can define a threshold time period that has to pass before the Widget alerts the user. Once the Widget determines that the Widget is disconnected from the Smart Device, if the Widget comes back into the range before the threshold time period expires, the Widget does not alert the user. However, if the Widget remains disconnected after the threshold time period exceeded, the Widget alerts the user as described above.

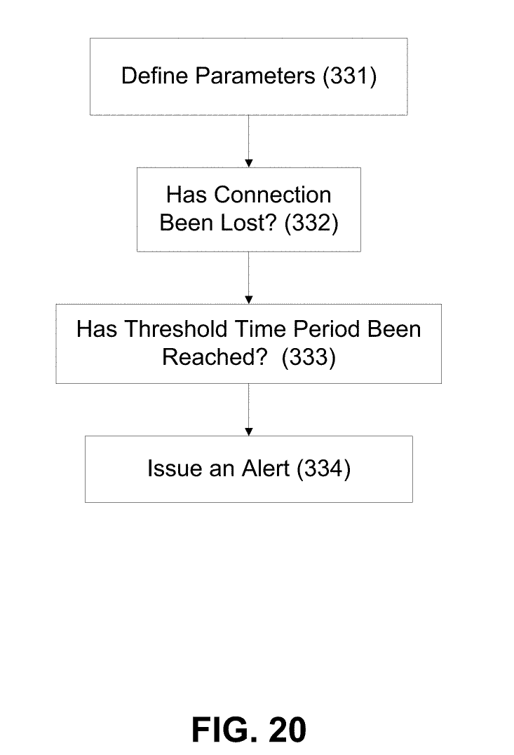

FIG. 20 shows a flow process for notifying a user via the Widget when the user leaves the user's Smart Device behind. In step 331, the user defines a set of parameters for alerting the user in case the Smart Device is left behind. For example, the user can define how often the Widget monitors the connection between the Widget and the Smart Device, or the user can define the threshold time period after which the Widget alerts the user about lack of connectivity between the Widget and the Smart Device. These parameters can be defined at the Smart Software or at the Widget Software. In case these parameters are defined at the Smart Software, the Smart Software communicates these parameters to the Widget Software. In step 332, the Widget continuously or intermittently detects the connection between the Widget and the Smart Device, and the Widget determines whether the connection has been lost. In step 333, the Widget determines whether the connection has been lost for longer than the threshold time period. If the connection has been lost for longer than the threshold time period, then at step 334, the Widget alerts the user.

In some embodiments, the Widget acts as an outside identifier of the user. For example, the user determines a set of information that the user intends to share and the Widget displays this information. In a first example embodiment, the user visits the Smart Software on the Smart Device and selects a media to be displayed on the Widget. The media can be an image, a video, a color, text, etc. Responsive to this selection by the user, the Smart Software can manipulate the media to be displayed on the Widget. For example, if the image is a rectangular image, the software can crop the corners of the image so that a circular image is presented (if the Widget is the shape of a circle). As another example, the Smart Software can enclose the rectangular image in a colored circle to be displayed on the Widget (which is the shape of a circle). Subsequently, the Smart Software causes broadcasting of the media, using the transmitters of the Smart Device onto the Widget, and in response, the transceivers of the Widget receive the broadcasted media and display the manipulated media onto the display screen of the Widget.

The manipulation of the media can take place at the Smart Software or the Widget Software. If the manipulation takes place at the Smart Software, the Smart Software provides the manipulated media to the Widget Software for displaying on the display screen.

In a second example embodiment, the user selects an application within the Smart Device to generate the media to be displayed on the Widget. In this example embodiment, the user visits the Smart Software and selects an application that is going to provide the media for the Widget. For example, this application can be an application that shows a short video clip. The user can manipulate how the media provided by this application is going to displayed on the Widget, e.g., the user can select part or all of the images produced by this application to be broadcast on the Widget. In response to this selection, the Smart Software transmits the media to the Widget, and the transceivers of the Widget receive the manipulated images, and display them onto the display screen of the Widget.

In yet another example embodiment, the Widget acts as a notifier of third parties. In this example embodiment, a third party sends a notification to the Smart Device and the Smart Device projects this notification onto the Widget. This functionality of the Widget can be helpful in various situations. For example, in a very large retail stores, locating customers who call for assistance has been a challenge for associates of the store. Oftentimes, a customer calls for help, and the associate arrives a few minutes later. However, when the associate arrives, the associate does not know which customer asked for assistance. Using the Widget, the associate can send a notification to the Smart Device of the customer who sought assistance. Upon receiving the notification, the Widget of the customer can alert both the customer and the associate. For example, the Widget of the customer can flash red, which provides a visual clue for the associate to identify the customer. Similarly, the Widget can vibrate to inform the customer that the associate has arrived.

As another example, in a restaurant setting, customers may be waiting to be seated. In some restaurants, the waiting customers are provided with beepers to be alerted that their table is ready. Using the Widget, the need for beepers can be obviated. When the table is ready, the hostess or host can send a notification to the Smart Device of the customer whose table is ready. In response to the notification, the Smart Device of the customer projects the notification onto the Widget of the customer permitting the hostess or host to identify the customer. Simultaneously, the customer can be alerted by a vibrating Widget.

In the context of dating and social media, the Widget can provide assistance to users of the Widget as well. When meeting, for the first time, a person scheduled for a “date” via a dating app, the Widget can notify the two parties of their proximity and display an external notification of mutual identification. Additionally, in social settings, oftentimes it is difficult for individuals to start a conversation with strangers. Using the Widget, the individuals can receive notification of shared interests each party has indicated via the Widget Software, and therefore the Widget acts as a “social lubricant” facilitating conversation and social interaction.

For example, users of a dating application identify various information or classes of information about themselves to be shared with the dating application of other users when they meet in person. Once two users of the dating application are within the vicinity of one another, the dating application can identify a common set of information between the users, and can project this information onto the Widget of each user, thereby facilitating contact between the users, and acting as a “social lubricant.”

The Widget can also act as a “marketplace” facilitator, whereby persons with complimentary needs can identify and meet to conduct a mutually-elected transaction. By example, at a crowded location near the gate of a stadium, one person looking to purchase tickets to a sporting event at a given maximum price could be “matched” to another person looking to sell tickets to that event at a given minimum price when the details of the transaction meet both party's requirements. Both parties would receive an external visual and vibration notification that a “match” was found, and via the Widget may now readily identify one another within the crowd.

The Widget may also be used for security identification, for example at a business, event hall, or residence. A user could be permitted, via an application, to have security access for a given building, facility, floor, or geo-fenced region. The Widget can, upon entering the region, or upon scanning by Bluetooth, RFID, NFC or other method, externally display the user's face, or other symbol, surrounded by either a green circle, red “X,” or other signifier, indicating approval or disapproval for access. In this way the Widget facilitates security, speeds access, and lessons the work load for security personnel.

In an example embodiment, the Widget can be used as a camera for capturing a still or video image. A user can use the camera to create a journal of daily activities and the events around the user. The camera can be activated by touch, voice command, or instructions generated from the Smart Software, the Widget Software, an artificial intelligence, or machine learning from a connected Smart Device. For example, upon receiving a voice command via the microphone of the Widget, the Widget Software can activate the camera of the Widget. As another example, the voice command can be received via a microphone of the Smart Device paired with the Widget. Once the command is received via the Smart Device, the Smart Device can transmit a command to the Widget. The transceiver of the Widget can receive this command, and the processing circuitry of the Widget is configured to activate the camera of the Widget. The video recorded via the camera can be stored in a memory of the Widget. However, it is also possible for the Widget to capture a video and transmit the video to the Smart Device paired with the Widget so that the video can be stored on the Smart Device.

In another example embodiment, the Widget can be used as a voice recorder to record notes or memos. For example, the microphone of the Widget can be always recoding sound inputs. However, it is also possible that the recording can be activated by a voice or a touch command, e.g., a trigger voice command to a “virtual assistant.” It is also possible for the recording to be activated by instructions from a Smart Software of a connected Smart Device. The voice recorded via the microphone can be stored in a memory of the Widget. However, it is also possible for the Widget to capture a sound and transmit the sound to the Smart Device paired with the Widget so that the sound can be stored on the Smart Device.

In yet another embodiment, the Widget can be used to participate in phone or video conversations. For example, upon receiving a phone or video call at the Smart Device, the Smart Device can transmit a signal to the Widget to activate the camera and the microphone of the Widget. Once activated, the camera and the microphone can capture video and sound, and transmit the recordings to the Smart Device via the transceiver of the Widget.

4. General Computer Functionalities

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, etc., or as a combination of one or more thereof. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to one or more hardware computer-readable media, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

The above description is intended to be illustrative, and not restrictive, and although the above description provides details for purposes of clarity of understanding, it will be apparent that certain changes and modifications may be practiced within the scope of the following claims. The invention is not to be limited to the details given herein, but may be modified within the scope and equivalents of the following claims. For example, those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited, because other modifications will become apparent to the skilled practitioner upon a study of the drawings, specification, and following claims. For example, the present invention may be practiced according to the claims without some or all of these specific details. For the purpose of clarity, technical material that is known in the technical fields related to the invention has not been described in detail so that the present invention is not unnecessarily obscured.

What is claimed

1. A device comprising:
a display screen; and
an outer housing including:
a processor;
a memory; and
a transceiver;
wherein:
the outer housing is attached to the display screen;
the outer housing is configured to be mounted on an article of clothing;
the processor is configured to receive via the transceiver a media from a smart device; and
the processor is configured to cause display of the media on the display screen.

2. The device of claim 1, wherein the processor is configured to adjust a brightness of the display screen according to a display pattern when displaying the media.

3. The device of claim 2, wherein the display pattern includes a duration and an intensity of the brightness of the display screen when displaying the media.

4. The device of claim 2, wherein responsive to a notification including the display pattern received by the transceiver from the smart device, the processor is configured to adjust the brightness of the display screen according to the received display pattern.

5. The device of claim 3, wherein the notification includes the media.

6. The device of claim 1, further comprising a vibrating motor.

7. The device of claim 6, wherein the processor is configured to cause a vibration of the vibrating motor according to a vibration pattern.

8. The device of claim 7, wherein the vibration pattern includes a duration and an intensity for the vibration of the vibrating motor.

9. The device of claim 7, wherein responsive to a notification including the vibration pattern received by the transceiver from the smart device, the processor is configured to vibrate the vibrating motor according to the received vibration pattern.

10. The device of claim 9, wherein the notification includes the media.

11. The device of claim 1, wherein the media is an image, a video, or a text.

12. The device of claim 1, further comprising a plate configured to connect to the outer housing and mount onto the article of clothing.

13. The device of claim 12, wherein the plate is configured to detachably connect to the outer housing.

14. The device of claim 13, wherein the plate is configured to detachably connect to the outer housing using a magnet, an adhesive, a Velcro, or a clip connection.

15. The device of claim 12, wherein the plate is configured to permanently connect to the outer housing.

16. The device of claim 12, wherein the plate includes a safety pin or a pin configured to be secured to a closure.

17. The device of claim 12, further comprising a frame configured to receive the outer housing and the plate.

18. The device of claim 17, wherein the plate is configured to detachably connect to the frame.

19. The device of claim 1, further comprising a frame configured to receive the outer housing.

20. The device of claim 1, wherein the outer housing is the shape of a square, a rectangle, or a circle.
